(19) United States
(12) Patent Application Publication
(10) Pub. No.: US 2014/0263089 A1
(43) Pub. Date: Sep. 18, 2014

(54) FRAC WATER SONIC TREATMENT

(71) Applicant: PetroSonic Energy Inc., Calgary (CA)

(72) Inventors: Art AGOLLI, Calgary (CA); Patrick BRUNELLE, Langdon (CA); Alfred FISCHER, Calgary (CA)

(73) Assignee: PetroSonic Energy Inc., Calgary (CA)

(21) Appl. No.: 14/209,333

(22) Filed: Mar. 13, 2014

Related U.S. Application Data
(60) Provisional application No. 61/787,926, filed on Mar. 15, 2013.

(51) Int. Cl. C02F 1/36

(52) U.S. Cl. CPC C02F 1/36
USPC 210/748.03; 210/205

(57) ABSTRACT

A system and process for frac water sonic treatment are disclosed. The process involve novel treatment in which frac water is cleaned to potable water standards using a proprietary sonic reactor. Treatment enable neutralization of toxins and may remove bacteria, oil, and/or heavy metals when contained in frac water. The novel treatment system includes portable and scalable equipment of design that may allow optimal economic operation to a plurality of industrial process using clean water.

### CROSS REFERENCE TO RELATED APPLICATIONS

This application claims priority to U.S. Provisional Patent Application Ser. No. 61/787,926, filed Mar. 15, 2013, entitled “Frac Water Sonic Treatment,” which is hereby incorporated by reference in its entirety.

### BACKGROUND

1. Field of the Disclosure

The present disclosure relates generally to water treatment systems and more particularly, to a system and process to remediate contaminated water with sonic treatment.

2. Background information

As a modern trend, oil and gas producers have turned to a process known as hydraulic fracturing, or “fracing,” in order better develop tight-gas reservoirs in deep rock formations. The fracing process is used pervasively throughout the industry because it is an efficient and economically beneficial process of extracting oil and gas from deep rock formations. The fracing process is typically carried out by injecting large volumes of a highly-pressurized fluid (water mixed with friction reducers, biocides, scale inhibitors, surfactants, and propping agents) into a well in order to induce and hold open structural cracks known as fractures. Once the fracing process is complete, the frac water is returned to the surface along with both the naturally-occurring water found in the oil and gas reservoir, and the extracted oil and gas targeted by the fracing process. The frac water returning to the surface can be potentially dangerous to the environment if it is not recovered and disposed of properly. Moreover, certain bacterial and pathogenic contaminates can prohibit a well producer from reusing the frac water after the initial fracing. This resulting waste can add significant costs to the drilling operation when horizontal well fracturing may use millions of gallons of water each time the well is fractured. Without the ability to reuse the frac water after the initial fracing, well producers must safely dispose of the contaminated frac water and purchase additional more frac water for subsequent fracing of the well.

In addition, water scarcity has become a widespread concern. It is known that the increased demand for water in energy-producing industries have found them at odds with the communities where they operate. Unchecked water pollution has led to forceful preventive environmental rules and regulations which have brought water treatment as the pre-eminent answer surrounding the issues.

Competing technologies for treating and recycling frac water has developed into offsite and onsite treatment technologies which may also be classified according to type of treatments. Accordingly, there are treatment solutions using thermal, physical filtration, and chemical technologies which may be used alone or in combination. While certain treatment technologies remove heavy metals and others destroy harmful bacteria, current systems cannot fully address the span of environmental concerns. Additionally, offsite treatment technologies, even though they are less restrictive on treatment rate and footprint than onsite treatment technologies, they involve higher operational costs.

Thermal treatment technologies may work on any type of water and remove all dissolved and suspended solids in the water to produce good quality, but no onsite configuration is available due to rate and footprint limitations which make them long-term costly solutions.

Physical treatment technologies may not provide suitable fluid treatment quality at a desired rate without involving an additional chemical treatment. Physical treatment technologies may be onsite, but require high capital cost.

Chemical treatment technologies may be mobile onsite or offsite treatment technologies using biocides and scale inhibitors even when water to be treated is relatively clean. They may treat water adjusting pH, managing bacteria in the water, and/or separating constituents that could cause additional problems during later utilization of the treated water. Up to date, the cost of chemical treatment technologies has been reasonable, but it may increase with industry demands for more effective mix of chemicals to produce better quality of water.

From the above, there may be a need for a water treatment technology that is mobile and capable of solving the difficulties in the current existing treatment technologies regarding rate and footprint, quality of the effluent produced, flexibility and cost effectiveness as a solution that may address environmental rules and regulations, as well as capable of mitigating health and safety concerns.

### SUMMARY

The embodiments of the present disclosure attempt to provide a system and process for economically treating frac water using sonication either onsite or offsite in applications requiring recycling of the water used in order to, for example, comply with environmental rules and regulations. The system and process for treating frac water may also, for example, serve as water processing plants to oil producers to eliminate contamination issues related to water discharges with total dissolved solids (TDS) within a range of about 300,000 ppm and provide clean water with TDS that may be within a range less than 125 mg/gal. This treated water may be used in subsequent hydraulic fracturing operations or may be injected in an underground disposal well.

The system and process for treating frac water with sonication may be employed to treat a plurality of contaminated water in tanks, underground wells and tanks, including but not limited to removal of oil, heavy metals, polymers, phosphate esters, bacteria, and neutralization of a full spectrum of toxins. Sonic treatment of frac water may recover about 90% of clean water.

Stages in the process may include the utilization of at least one proprietary sonic reactor to which frac water may be pumped from water tanks and/or reservoirs. Frac water may be mixed inside or outside the proprietary sonic reactor with chemicals that may be selected according to the plurality of contaminants. Mixing of frac water and chemicals in conjunction with sonication energy may produce an accelerated exothermic chemical reaction that may neutralize the plurality of toxins, remove bacteria, and collect oil, heavy metals, polymers and a full spectrum of contaminants to provide clean water which may meet potable water environmental standards.

Utilization of the system and process for frac water sonic treatment may provide advantages such as flexibility in water treatment rate and footprint, better economics because large volumes of water may be treated at lower cost, and at a totally different scale because the equipment required for the water treatment may be considered a compact and portable system, faster and scalable. System equipment may be set up in or proximate to the location of the frac water tanks and/or reservoirs and may produce innocuous components that may not necessarily be removed from the clean water.

In one embodiment, a method for processing contaminated water comprises storing the contaminated water in a storage container; analyzing the contaminated water for one or more contaminants; selecting one or more additives for mixing with the contaminated water based upon the analyzed contaminants; mixing the selected additives to the contaminated water to form a treated water; sonicating the treated water, comprising imparting a high intensity vibrational energy to the treated water; and removing one or more contaminants from the treated water. Sonicating can be performed by a sonicator controlled by at least one programmable controller. The sonicator can comprise at least one reaction chamber containing the treated water, and wherein programmable controller can cause the sonicator to impart vibrational energy on the treated water within the reaction chamber. The mixing can take place inside the sonicator. Sonicating can further comprise passing the treated water through the sonicator; imparting, by the sonicator, vibrational energy on the treated water; and controlling the flow of the treated water through the sonicator, wherein the time-exposure of the treated water to the vibrational energy is based upon a flow rate of the treated water. The vibrational energy may have amplitudes of at least 90 kW/m³. Removing may further comprise passing the treated water through a settling container, wherein one or more contaminants in the treated water are removed from the treated water to form purified water.

In another embodiment, a system for treating frac water comprises a container configured to store contaminated frac water; an analyzer configured to analyze the contaminated frac water for one or more contaminants; a mixer configured to blend one or more additives into the contaminated water to create a treated water; a sonicater configured to impart high intensity vibrational energy into the treated water; a separator configured to separate one or more contaminants from the treated water to form purified water; and a container configured to store the purified water. The sonicator may comprise at least one reaction chamber for holding the treated water, and wherein the high intensity vibrational energy may be imparted into the treated water in the reaction chamber. At least one programmable controller may be configured to control the sonicator, the controller capable of causing the sonicator to impart vibrational energy. The sonicator can impart vibrational energy having amplitudes of at least 90 kW/m³. A flow controller can be configured to control the rate of flow of the treated water through the sonicator.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 depicts a process flowchart for frac water sonic treatment, according to an embodiment of present disclosure.

FIG. 2 illustrates a process flow diagram of the system for frac water sonic treatment, according to an embodiment of present disclosure.

FIG. 3A depicts an isometric view of a sonicator, according to an embodiment of present disclosure.

FIG. 3B depicts a front view of a sonicator, according to an embodiment of present disclosure.

FIG. 3C depicts a first sectional view of a sonicator, according to an embodiment of present disclosure.

FIG. 3D depicts a second sectional view of a sonicator, according to an embodiment of present disclosure.

### DETAILED DESCRIPTION

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or other changes may be made without departing from the spirit or scope of present disclosure.

### Definitions

As used herein, the following terms may have the following definitions:

“Frac water” may refer to water contaminated with toxins, or bacteria, oil, and/or heavy metals.

“Sonication” may refer to a process for treating frac water in a low-frequency sonic reactor by application of pressure waves.

### DESCRIPTION OF THE DRAWINGS

Frac Water Sonic Treatment Process

FIG. 1 depicts a process flowchart for frac water sonic treatment 100, according to an embodiment of present disclosure. Processing provided in present disclosure may be initiated with frac water analysis in step 102. In this step, frac water resulting from a plurality of clean water usage operations, such as hydraulic fracturing operations amongst others, may be analyzed for contaminants content. Such contaminants may include certain bacteria and pathogens and minerals that were absorbed when the frac water was below surface and subsequently removed. Other contaminants may include that chemicals that were added to the frac water prior to pumping it underground in order to produce fissures in the subterranean composition. The resulting analysis in step 102 may provide the appropriate information for determining the selection of chemicals in step 104. In step 104, the chemicals or mix of chemicals which may be required to process frac water according to the principles in present disclosure, discussed in detail below. Chemicals selection step 104 may comprise, for example, selection of chemicals to neutralize toxins in the water, as well as to remove bacteria, oil, and/or heavy metals in the water. Flocculants and coagulants may also be used to attach to certain suspended particles. The selection of chemicals may also depend on the level of acidity of frac water to be treated considering existing environmental standards.

In-line mixing step 106 involves the mixing of the selected chemicals and frac water, which may contribute to achieving an optimal treatment of frac water to result in clean water. In certain circumstances, some chemicals may be left over by treatment and depending on the usage intended by the system operators. Mixing of frac water and chemicals may be performed in-line either inside or outside at least one proprietary sonic reactor (not shown), which may be used for frac water sonic treatment 100. In one preferred embodiment, in the in-line mixing step 106, frac water and chemicals may be statically or dynamically combined with solvent to form a stable and optimized mixture which may present the required blending/homogenization for an efficient sonication step 108.

In sonication step 108, the mixture of frac water-chemicals may be subjected to sonication with low frequency, high amplitude, high energy vibrational energy. Sonication step 108 may cause the formation and collapse of cavitation bubbles in the water sufficient to cause exothermic reactions and enable the neutralization of toxins and bacteria and the separation of oil, and heavy metals from the water, inside the chamber of the proprietary sonic reactor (not shown).The sonication process may significantly reduce processing time to a range of about two minutes up to 25 seconds depending on the frac water-chemicals mixture. In heavy metals removal step 110, oil and heavy metals may be removed and disposed according to environmental standards or may be used for additional recovery process. In clean water disposal step 112, clean water may be disposed into the environment or stored for subsequent utilization, depending on the operations in which the cleaned water may be required and local regulations.

Frac Water Sonic Treatment System

FIG. 2 illustrates a process flow diagram of frac water treatment system 200, according to an embodiment of present disclosure.

Frac water that may be processed into a cleaner or more purified water according to principles in present disclosure may come from different sources. Frac water may be either stored in frac water tanks 202 or in underground frac water reservoirs 204 which may be built in compliance with environmental standards.

Pumps 206 may be employed to feed frac water from either tanks or reservoirs and selected chemicals in chemical tank 208 to in-line mixer 210. Mixing of frac water and chemicals may be either inside or outside proprietary sonicator 212. In-line mixer 210 may not be necessary when frac water and chemicals are mixed inside the chamber of proprietary sonicator 212.

In sonicator 212, low-frequency, high-amplitude, and high-energy vibrational energy may be applied to the treated water during a range of time from about 5 seconds to about two minutes, depending on a number of factors, including the type of contaminants present and the level of purity that is sought to be achieved. The exposure of the treated water to the vibrational energy may be controlled by the rate at which the treated water flows through the apparatus. Energy inputs that may be required for a 20 KW to 50 KW sonicator 212 may be in a range of about 90 KW/m³ of reactor volume, which is equivalent to about 450 HP for every 1,000 American gallons. The high power input that may be required to optimize the sonication process may be of an order of 10 to 1000 times greater than results reached when energy intensive industrial mixing systems, such as flotation cells or standard agitation systems, amongst others, may be employed in treating frac water.

After the sonication process may be completed, depending on the content of frac water, separator 214 may be needed to remove oil and heavy metals, which may be in the frac water stored in tanks and/or reservoirs. Examples of separators may include mechanical filters, evaporators, cation beds, and settling tanks. In some embodiments, separator 214 may be optional and at the end of sonication process clean water from proprietary sonicator 212 may be determined to be fit to be returned to the environment and, for example, be placed in a reservoir 216. The water may be available for cycles of potability for human consumption, because toxins may have been neutralized by selected chemicals and sonic treatment. The water may be in a state with chemicals that are not prejudicial to fauna and flora where the clean water is to be disposed in reservoir 216. Clean water may also be stored underground in recycling tanks 218 for use in a plurality of operations which may demand clean water per environmental standards.

When oil and/or heavy metals are identified in the frac water being treated, separator 214 may enable their separation and appropriate disposal to specific disposal sites 220 in compliance with environmental standards or may be made available for other processing operations.

FIG. 3A shows isometric view 302 of sonicator 300. FIG. 3B shows front view 304, FIG. 3C depicts right plane section 306, and FIG. 3D depicts front plane section 308.

Sonicator 300 is shown having support structure 310, resonant bar 312, and a set of magnet configuration 314, resonant bar supports 316, and reaction chamber 318 on each end of resonant bar 312.

Sonicator 300 may be used for frac water sonic treatment 100, according to principles in present disclosure. Sonicator 300 may use support structure 310 to hold resonant bar 312 in place using any suitable support as resonant bar supports 316. Suitable configurations for resonant bar supports 316 may include configurations including a plurality (e.g., three or more) rubber-air cushions, which may enable some isolation and movement of the resonant bar 312 with respect to the support structure 310. Any suitable electro-magnet configuration 314 may also be held by support structure 310, placed around or proximate to resonant bar 312 and, when activated by a control module (not shown), may cause resonant bar 312 to vibrate the frac water. Within resonant bar 312 may be one or more reaction chambers 318 through which frac water may be passed and subjected to vibrational energy when the electro-magnet configuration 314 is activated, applying an oscillating mechanical force. Suitable configurations for electromagnet configuration 314 include configurations with at least three magnets and power suitable to cause resonant bar 312 to vibrate. In one embodiment, the core of the electromagnets 314 may be ferrous and rigidly connected to the resonant bar 312 while the coils of the electromagnet 314 may be rigidly connected to the support structure 310, thereby allowing for the relative movement of the ferrous core when the electromagnet coils are energized. Control module (not shown) may energize each electro-magnet in unison or separately according to a defined and/or adjustable phase-shift relationship.

Frac water in reaction chamber 318 may have previously been chemically altered to allow the upgrading to clean water per environmental standards in reaction chamber 318, methods for preparing it for such including the addition of one or more chemicals.

The period of time needed to treat frac water in reaction chamber 318 may vary in dependence with a number of factors, including the amplitude and frequency of the vibration of resonant bar 312. The treatment time for the water may be, for example, controlled by adjusting the flow rate of the frac water through the reaction chamber 318. The amplitude and frequency of the vibration of resonant bar 312 may in turn depend on the mass of resonant bar 312 and the mass of reaction chamber 318.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A method for processing contaminated water, the method comprising:
storing the contaminated water in a storage container;
analyzing the contaminated water for one or more contaminants;
selecting one or more additives for mixing with the contaminated water based upon the analyzed contaminants;
mixing the selected additives to the contaminated water to form a treated water;
sonicating the treated water, comprising imparting a high intensity vibrational energy to the treated water; and
removing one or more contaminants from the treated water.

2. The method of claim 1, wherein sonicating is performed by a sonicator controlled by at least one programmable controller.

3. The method of claim 2, wherein the sonicator comprises at least one reaction chamber containing the treated water, and wherein programmable controller causes the sonicator to impart vibrational energy on the treated water within the reaction chamber.

4. The method of claim 2, wherein the mixing takes place inside the sonicator.

5. The method of claim 1, wherein sonicating further comprises:
passing the treated water through the sonicator;
imparting, by the sonicator, vibrational energy on the treated water; and
controlling the flow of the treated water through the sonicator,
wherein the time-exposure of the treated water to the vibrational energy is based upon a flow rate of the treated water.

6. The method of claim 1, wherein the vibrational energy has amplitudes of at least 90 kW/m³.

7. The method of claim 1, wherein removing further comprises:
passing the treated water through a settling container,
wherein one or more contaminants in the treated water are removed from the treated water to form purified water.

8. A system for treating frac water comprising:
a container configured to store contaminated frac water;
an analyzer configured to analyze the contaminated frac water for one or more contaminants;
a mixer configured to blend one or more additives into the contaminated water to create a treated water;
a sonicater configured to impart high intensity vibrational energy into the treated water;
a separator configured to separate one or more contaminants from the treated water to form purified water; and
a container configured to store the purified water.

9. The system of claim 8, wherein the sonicator comprises at least one reaction chamber for holding the treated water, and wherein the high intensity vibrational energy is imparted into the treated water in the reaction chamber.

10. The system of claim 8, further comprising:
at least one programmable controller configured to control the sonicator, the controller capable of causing the sonicator to impart vibrational energy.

11. The system of claim 10, wherein the sonicator imparts vibrational energy having amplitudes of at least 90 kW/m³.

12. The system of claim 8, further comprising:
a flow controller configured to control the rate of flow of the treated water through the sonicator.
